(19) United States
(12) Patent Application Publication
(10) Pub. No.: US 2005/0273964 A1
(43) Pub. Date: Dec. 15, 2005

(54) Paint rollers

(76) Inventor: Stuart Hobbs, Shifnal (GB)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/152,574

(22) Filed: Jun. 14, 2005

(30) Foreign Application Priority Data
Jun. 15, 2004 (GB) 0413325.2

(51) Int. Cl. B05C 21/00

(52) U.S. Cl. 15/236.03

(57) ABSTRACT

A paint roller cleaning device is in the form of a tubular sleeve member defining a through bore sized to receive a generally cylindrical paint roller. An internal annular rib intermediate the ends of the sleeve member defines an orifice of reduced cross-section relative to the roller such that the roller is compressed by the rib as it passes through the orifice and paint is removed from the surface of the roller by contact with the marginal edge of the orifice.

### CROSS-REFERENCE TO RELATED APPLICATIONS

This application claims priority under 35 U.S.C. §119 to United Kingdom patent application Number GB 0413325.2, entitled IMPROVEMENTS IN OR RELATING TO PAINT ROLLERS that was filed on Jun. 15, 2004.

### STATEMENT REGARDING FEDERALLY SPONSORED RESEARCH OR DEVELOPMENT

Not applicable.

### FIELD OF THE INVENTION

This invention concerns improvements in or relating to paint rollers. More especially, the invention concerns a device for cleaning the roller after use and to a method of cleaning the roller using the device.

### BACKGROUND OF THE INVENTION

Paint rollers are widely used in preference to brushes for applying paint to flat surfaces such as a wall or a ceiling. Large areas can be covered more quickly with a roller and often the finish is better than can be achieved with a brush.

Rollers come in a variety of materials depending on the type of paint to be used and the surfaced finish required. Typical materials are foam sponges and pile fabrics.

In use, the roller becomes saturated with paint and this has to be removed when the roller is cleaned after use if it is desired to re-use the roller. This is wasteful of water and any other cleaning materials used, for example solvent based cleaners and is a very time consuming process.

Attempts to reduce the amount of cleaning materials used have been made and it is known to remove excess paint from the roller with a blade-like tool that is scraped across the surface of the roller. Such tools are relatively ineffective however as the paint is simply moved to the side of the roller that is not being scraped. Also, it is difficult to apply any force to the roller with these tools and/or to collect any paint that is removed.

### SUMMARY OF THE INVENTION

The present invention has been made from a consideration of the foregoing problems and seeks to provide a device for removing paint from a roller and a method of cleaning a roller using the device.

According to a first aspect of the invention there is provided a device for cleaning a roller, especially a paint roller, the device comprising a sleeve member through which a roller can be passed to remove paint from the roller.

Preferably, the sleeve member is sized to compress the material of the roller so that paint is removed from the roller as it passes through the sleeve member.

Preferably, the sleeve member has an internal formation, for example an annular rib, defining an orifice of reduced cross-section relative to the roller in an uncompressed condition. In this way, the roller is at least partially compressed as it passes through the orifice and paint released by compression of the roller is retained by the formation.

Preferably, the internal formation is provided intermediate entry and exit ends of the sleeve member, and the sleeve member is provided with internal webs that extend axially on either side of the orifice and are circumferentially spaced apart to center the roller in the sleeve member.

Preferably, the entry end of the sleeve member is tapered to assist insertion of the end of the roller into the sleeve member and to guide the roller towards the orifice.

Preferably, the sleeve member is provided with an external formation, for example an annular collar, for the user to apply a force for relative axial movement between the roller and sleeve member. The collar may also provide a guard shielding the user from paint, removed from the roller as it passes through the sleeve member.

Preferably, the entry end is shaped to direct paint that is removed from the roller together with solvent cleaner such as water applied to the roller as it passes through the sleeve member and allow the paint/solvent to be returned easily to a storage container for disposal.

According to a second aspect of the invention, there is provided a method of removing paint from a roller comprising the steps of providing a tubular sleeve member and passing a roller through the sleeve member to at least partially compress the roller and remove paint from the roller.

The invention will now be described in more detail, by way of example only, with reference to the accompanying drawings.

### BRIEF DESCRIPTION OF THE DRAWINGS

FIG. 1 is a side view of a device embodying the invention;

FIG. 2 is an end view of the device shown in FIG. 1; and

FIG. 3 is a longitudinal sectional view of the device shown in FIG. 1.

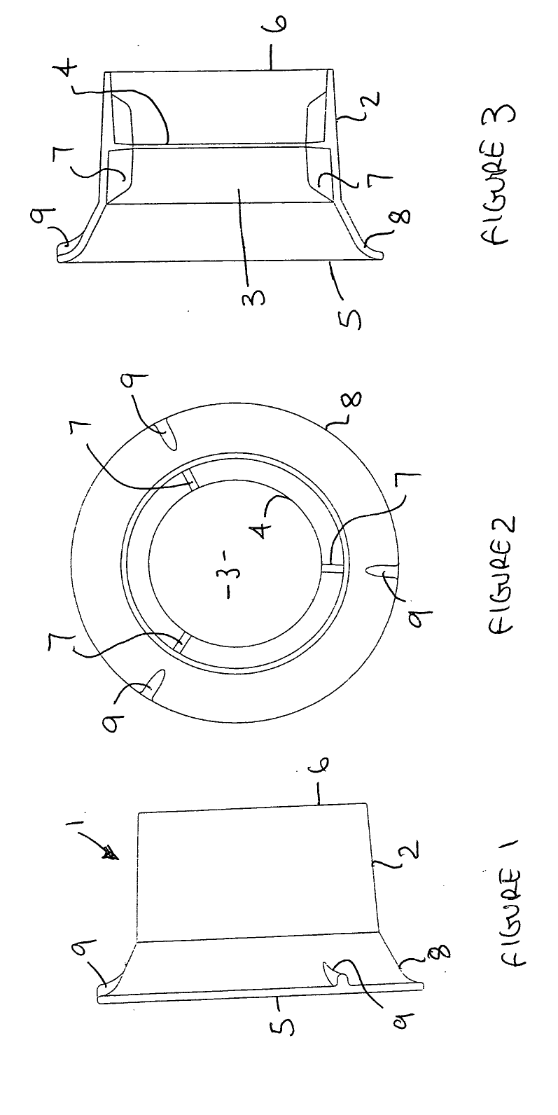

### DETAILED DESCRIPTION OF THE EXEMPLARY EMBODIMENT

Referring to the drawings, there is shown a device 1 for removing paint from a roller (not shown) of the type used to paint walls and ceilings although it will be understood the invention is not limited to such rollers. The roller comprises a cylindrical member detachably mounted on a rotatable cage connected to a handle. The member has an outer surface of a compressible material such as sponge foam or pile fabric that carries the paint to be applied by rolling the member over the surface to be painted, for example a wall or ceiling. Such rollers are well known.

The device 1 comprises a tubular sleeve member 2 having a through bore 3 sized to receive the roller lengthwise and an internal formation in the form of an annular rib 4 defining an annular orifice of reduced cross-section relative to the outer diameter of the roller in an uncompressed condition.

The rib 4 is provided intermediate entry and exit ends 5 and 6 respectively of the sleeve member 2. On each side of the rib 4, the bore 3 is divergent from the rib 4 towards the entry and exit ends 5 and 6 respectively.

The sleeve member 2 is provided with three internal webs 7 that extend axially on either side of the rib 4 and are uniformly spaced in a circumferential direction to reinforce the rib 4 and assist in centering the roller in the bore 3.

The bore 3 terminates in an outwardly flared formation in the form of a collar 8 at the entry end 5 of the sleeve member 2 that assists initial insertion of the end of the roller in the bore 3 and provides an abutment for a user to apply a force to the sleeve member 2. This makes it easier to effect relative axial movement between the sleeve member 2 and roller for moving the sleeve member 2 lengthwise of the roller. The collar 8 is provided with three external ribs 9 aligned with the webs 7 that reinforce the collar 8.

In use, a roller (not shown) that is saturated with paint after use is inserted lengthwise into the entry end 5 of the sleeve member 3. The collar 8 guides the end of the roller into the convergent portion of the bore 3 and the webs 7 act to center the roller in the bore 3.

The roller is guided towards the rib 4 and is compressed as it passes through the orifice defined by the rib 4. As a result of such compression, paint released onto the surface of the roller is removed by contact with the marginal edge of the orifice as the roller passes through the orifice and is retained by the rib 4.

On passing through the orifice, the roller material can expand slightly as it moves towards and passes out of the exit end 6 of the sleeve member 2. The roller remains centered in the bore 3 due to the webs 7.

Paint that is removed from the roller by the rib 4 is contained in the bore 3 and can be returned to a suitable container (not shown) for disposal using the collar 8 as a pouring lip.

The sleeve member 2 can be pushed along the roller from one end to the other by the user pressing against the collar 8 which acts as a guard to shield the user from contact with the roller and any paint removed from the roller.

The roller may be passed through the sleeve member several times to remove substantially all the paint from the roller before applying water or solvent cleaner to the roller. Final cleaning of the roller to remove any remaining traces of paint can be effected in the normal way using water or any other suitable solvent cleaner depending on the type of paint. Alternatively or additionally, the roller may be passed through the sleeve member during cleaning with water or solvent cleaner to assist removal of paint or solvent.

As will now be appreciated the invention provides a device that can be used to remove paint from a roller in a simple, efficient manner that allows the roller to be re-used. Moreover, paint removed from the roller can be collected in a container for disposal. Furthermore, the amount of cleaning with water or solvent cleaner can be significantly reduced with benefits for both the user and the environment. Additionally, the time taken to clean the roller may be reduced by use of the device.

The device 1 may be made of any suitable materials but is conveniently a plastic molding sized to receive rollers that can pass through the device with appropriate compression of the roller material to remove paint contained therein.

There may provided a set of devices of different sizes for accommodating different roller sizes and/or materials. The device may be supplied with a roller and/or roller support cage and may be a detachable part of the roller cage and/or roller handle.

Other features benefits and advantages of the invention will be apparent to those skilled in the art.

1. A device for cleaning a paint roller, the device comprising a sleeve member through which a generally cylindrical paint roller can be passed lengthwise to remove paint from the roller.

2. A device according to claim 1 wherein said sleeve member is sized to compress the material of the roller so that paint is removed from the roller as it passes through said sleeve member.

3. A device according to claim 1 wherein said sleeve member has an internal formation defining an orifice of reduced cross-section relative to the roller in an uncompressed condition.

4. A device according to claim 3 wherein said formation comprises an annular rib.

5. A device according to claim 3 wherein said internal formation is provided intermediate an entry end and an exit end of said sleeve member.

6. A device according to claim 5 wherein said sleeve member is provided with internal webs that extend axially on either side of said orifice and are circumferentially spaced apart to center the roller in said sleeve member.

7. A device according to claim 5 wherein said entry end of said sleeve member is tapered to assist insertion of the end of the roller into said sleeve member and to guide the roller towards said orifice.

8. A device according to claim 1 wherein said sleeve member is provided with an external formation for a user to apply a force for relative axial movement between the roller and said sleeve member.

9. A device according to claim 8 wherein said external formation comprises an annular collar.

10. A device according to claim 9 wherein said collar provides a guard shielding a user from paint removed from the roller as it passes through said sleeve member.

11. A device according to claim 5 wherein said entry end is shaped to contain paint that is removed from the roller together with solvent cleaner applied to the roller as it passes through said sleeve member.

12. A method of removing paint from a roller comprising the steps of providing a tubular sleeve member and passing a roller through said sleeve member to at least partially compress said roller and remove paint from said roller.

13. A paint roller cleaning device comprising:
a tubular sleeve member having any entry end and an exit end and a bore between the entry end and the exit end; and
an annular rib positioned within the sleeve member between the entry end and the exit end.

14. The paint roller cleaning device of claim 13 wherein the entry end is tapered outwardly.

15. The paint roller cleaning device of claim 13 wherein the tubular sleeve member has a diameter and the device further comprising an annular collar positioned at the entry end with the collar having a diameter greater than the diameter of the member.

16. The paint roller cleaning device of claim 15 wherein the collar provides a guard for shielding a user from paint removed from a paint roller.

17. The paint roller cleaning device of claim 13 further comprising internal webs spaced circumferentially apart to center a paint roller inserted into the sleeve member.

18. The paint roller cleaning device of claim 13 further comprising an annular collar positioned at the entry end with the collar having webs that extend axially and are circumferentially spaced apart to center a paint roller inserted into the sleeve member.

19. The paint roller cleaning device of claim 13 wherein the entry end is shaped to contain paint removed from a paint roller inserted into the sleeve member.

20. The paint roller cleaning device of claim 13 wherein the rib is sized to compress a paint roller inserted into the sleeve member to remove paint from a paint roller as a paint roller passes through the sleeve member.
